(19) United States
(12) Patent Application Publication
(10) Pub. No.: US 2004/0093263 A1
(43) Pub. Date: May 13, 2004

(54) Automated Interview Method

(76) Inventors: Malchiel A. Doraisamy, Sarasota, FL (US); Gilbert R. Bailie, Tampa, FL (US)

Correspondence Address: SMITH & HOPEN PA, 15950 BAY VISTA DRIVE, SUITE 220, CLEARWATER, FL, 33760

(21) Appl. No.: 10/250,013

(22) Filed: May 28, 2003

Related U.S. Application Data
(60) Provisional application No. 60/383,910, filed on May 29, 2002.

(51) Int. Cl. G06F 17/60

(52) U.S. Cl. 705/11

(57) ABSTRACT

A method of automating an interview process including the steps of broadcasting prerecorded video interview questions to an interview subject at a first location. Responses to the questions by the interview subject are videoed and saved on a storage device. The responses are then replayed through a computer network interface at a second location.

RELATED APPLICATION

This disclosure is a continuation-in-part of a co-pending disclosure of the same title by the same inventors, filed May 29, 2002, bearing serial No. 60/383,910.

### BACKGROUND OF INVENTION

1. Field of Invention

This invention relates to a method of administering interviews, and more particularly, a method of presenting questions and capturing responses by audio-visual media.

2. Background of Invention

All large organizations, public or private, bear the cost of interacting with vast numbers of people every working day. Historically, there was scant opportunity for efficiency in the process of managing necessary contacts with internal and external clienteles. Instead, the most common response to an expansion of an organization's workload was a parallel growth in staff size, a solution that could only create more interaction to manage.

In recent years large organizations have been able to attack a portion of their “people problems” with new technology. Internal and external inquires and messages, for example, now are fielded and distributed automatically via computerized telephone answering systems. In addition, large organizations have learned that posting detailed information on web sites actually can pre-empt routine inquires from internal and external audiences.

Yet inquires and messages account for just a fraction of the contacts that organizations must manage. The largest portion of any organization's workload comes instead from face-to-face interaction with clients, customers, employees and applicants.

### SUMMARY OF INVENTION

The present invention is a method of automating an interview process including the steps of broadcasting at least one or more prerecorded video interview questions to an interview subject at a first location. The prerecorded questions may relate to numerous situations including, but not limited to an employment opportunity, a worker's compensation claim, a Medicare or corporate health insurance application, the welfare of a child and/or family, a parole or probation meeting, an arrest booking, an immigration application or a homeland security evaluation. Responses to the questions by the interview subject are video captured and saved on a storage device for replay through a computer network interface at a second location. Each video captured response may be associated with the prerecorded video interview question and indexed in an array of responses whereby an individual reviewing the interview subject's responses may skip to a response to a single prerecorded interview question. This non-linear review process greatly enhances efficiency, as certain responses may be dispositive in the evaluation process while other responses are of less concern. The video responses may be stored in a number of formats. In one embodiment, each video captured response is stored as an individual file. In another embodiment of the invention a plurality of video captured responses are stored as a single file with headers identifying the start of each response to a single prerecorded interview question. Alphanumeric data such as a resume, biographical record, or other data associated with the interview subject may be stored in the single file. In addition to the alphanumeric data, binary data, such as a digitized portrait of the interview subject may also be stored in the single file. Upon decompression of the single file, text, images and video data are parsed from each other and presented in a predefined format. Preferably, the single file is encrypted.

The responses by two or more interview subjects may be presented substantially simultaneously at the second location for comparison. This may be particularly useful if two job candidates are closely qualified for a single job opening. In an embodiment of the invention, at least one of the two or more interview subjects is an employee having a known performance record. For example, a known high performing saleswoman with a previously recorded interview may serve as an ideal model for future hires. Utilizing previously recorded interview responses is also valuable for training the individuals that review the recorded interview responses and make decisions based on their evaluations. Preselected model interview subjects are broadcast to a reviewer for evaluation and appraising the reviewer's evaluation abilities in selecting a preferred model interview subject.

Where sensitive interviews are conducted a hash may be generated of the interview subject responses at the conclusion of the interview and transmitted to a trusted third party. Should the video captured responses be tampered with, the previously generated hash may be used to invalidate the authenticity of the modified responses. By generating a hash, the legal admissibility and trustworthiness of the captured responses is substantially increased.

An advantage of the present invention is its ability to ensure legal compliance in the administration of the questions. An array of predetermined interview questions is established and communicated to legal counsel. Legal counsel approves or rejects the legality of each question whereby only those questions that have been approved are presented to the interview subject. Laws change and judicial interpretations evolve; accordingly, the legal compliance of a question may also change over time. In a preferred embodiment of the invention, the date when each question was last reviewed for legality is recorded and a predetermined expiration date is associated with the question for revisiting the legality of the question at a later date. The frequency in which each approved question is broadcast to an interview subject may be recorded and the legal counsel that previously approved the legality of the question may be paid a royalty for each broadcast. In similar fashion to legal counsel, each prerecorded video interview question may be associated with an actor playing the part of the interviewer whereby the actor is paid a royalty to the actor for each broadcast of the question.

A plurality of interview styles may be established. For example, some styles might be more casual while others more formal. Actors presenting interview questions in accordance with each style are recorded and a selection means for selecting the style of interview to be broadcast may be controlled by the interview subject or an interview administrator.

Interview questions vary broadly for different industries and occupations. Accordingly, arrays of related questions may be grouped together into templates with a selection means for selecting the template desired. Further customization of the interview template may be achieved by selecting or de-selecting individual questions within the template itself. During the selection or de-selection process, the prerecorded video interview questions may be previewed.

An advantage of individually accessing each individual question broadcast to the interview subject is that the broadcast is nonlinear. The broadcast of one or more prerecorded video interview questions is dependent upon an interview subject's response to one or more preceding questions. The interview subject's responses may be captured by a mechanical input device including, but not limited to, a mouse, touch screen, keyboard, trackball or the like. Alternatively, the interview subject's response may be captured by voice recognition. Preferably, the interview subject is presented with a limited number of verbal responses available such as “YES” or “NO” whereby the voice recognition processing is kept to a minimum and interpretation errors are minimized.

Biometric data may be captured concurrently with responses to the questions by the interview subject. The biometric data may be based on physical attributes captured on video such as, the shape of the interview subject's face or the retinal signature. In addition, the biometric data may be polygraphic-based, such as, thermal imaging, pulse rate, blood pressure or speech stress or identity analysis.

In an embodiment of the invention, at least one or more prerecorded video interview questions are selectably broadcast in multiple languages. In one method according to the invention, an interview subject that claims foreign language ability may be spontaneously asked questions in the language for which they claim proficiency.

The first location in which the prerecorded interview questions are broadcast may be variable. A kiosk may be placed permanently in locations that are frequented by job applicants or by governmental agencies. A first example might be placing the kiosk in a large retail establishment for prescreening interview subjects applying for a job. Another example might be at a probation office wherein the person on probation must periodically check in and answer predetermined question on meeting his or her obligations under probation. Yet another example involves placing the kiosk at an airport security station for interviewing individuals that pose safety or immigration concerns. The kiosk may also be deployed on a temporary basis such as at job fairs or seminars. The first location may also be a home computer terminal. Interviewing subjects at home is convenient for all parties and may be particularly appropriate for individuals with disabilities. The first location may also be mobile with the prerecorded video interview questions broadcast by a portable computing device. This method may be appropriate for child and family welfare visits to the interview subject's residence. In addition to video capturing responses by the interview subject, the environmental conditions of the residence that may impact the welfare of the children and family may also be documented with video.

The present invention provides for the review and evaluation of the interview subject by multiple decision-making parties. For example, a first evaluation of the interview subject made and recorded by a first party, may then be replayed at the second location. The first evaluation of the first party and the responses by the interview subject are then displayed to a second party wherein a second evaluation of the interview subject by the second party is also recorded. By adopting this workflow arrangement for evaluation, the speed and efficiency of the process is greatly enhanced. In addition, the first and second parties may reside at the same or different locations.

In another embodiment of the invention, prerecorded video questions may be used to administer online aptitude tests and to collect online form data.

An advantage of the present invention is that all interviews are conducted by the ideal interviewer. The interviewer can be an employee, a chief executive office, a governor or a professional actor.

Another advantage of the present invention is the system knows no linguistic or cultural barriers. Interview subjects can be allowed to select the language and can even be offered the chance to choose among different virtual interviewers.

Another advantage of the present invention is that video interviews are standardized. The same questions are asked precisely the same way every time, ensuring equality of opportunity for everyone who is interviewed.

Another advantage of the present invention is that interviews are complete. Preselected questions for an interview cannot be omitted by mistake.

Another advantage of the present invention is that authorized personnel can access video interviews and attachments at any time from any place using a variety of computing devices. Colleagues can collaborate on decisions even if they are half a world apart. Furthermore, supervisors can monitor the activities of field offices without leaving headquarters.

### BRIEF DESCRIPTION OF DRAWINGS

For a fuller understanding of the nature and objects of the invention, reference should be made to the following detailed description, taken in connection with the accompanying drawings, in which:

FIG. 1 is a depiction of the client interface according to an embodiment of the invention.

FIG. 2 is a diagrammatic view of an embodiment of the invention.

FIG. 3 is a depiction of the client interface on a tablet computer in a first configuration.

FIG. 4 is a depiction of the client interface on a tablet computer in a second configuration.

FIG. 5 is a diagrammatic view of a timeline recording method according to an embodiment of the invention.

FIGS. 6-7 are diagrammatic views of an embodiment of the timeline recording method for comparing two or more subjects.

FIG. 8 is a diagrammatic view of method of comparing potential applicants against current employees according to an embodiment of the invention.

FIG. 9 is a diagrammatic view of recording multiple interview styles according to an embodiment of the invention.

FIG. 10 is a diagrammatic view of a client selection interface for choosing one of the multiple interview styles.

FIG. 11 is a diagrammatic view of a client selection interface for choosing from an array of preexisting interview templates.

FIGS. 12-13 are computer screen interfaces for modifying a preexisting interview template.

FIG. 14 is a diagrammatic view of exemplary table relationships for storing and retrieving interview data.

FIG. 15 is a computer screen interface showing a royalty report for an actor that performs interview questions broadcast by the system.

FIG. 16 is a computer screen interface showing statistics on the number of interview questions that have been validated by legal counsel as appropriate.

FIG. 17 is a computer screen interface showing a royalty report for a law firm that approves interview questions broadcast by the system for legal compliance.

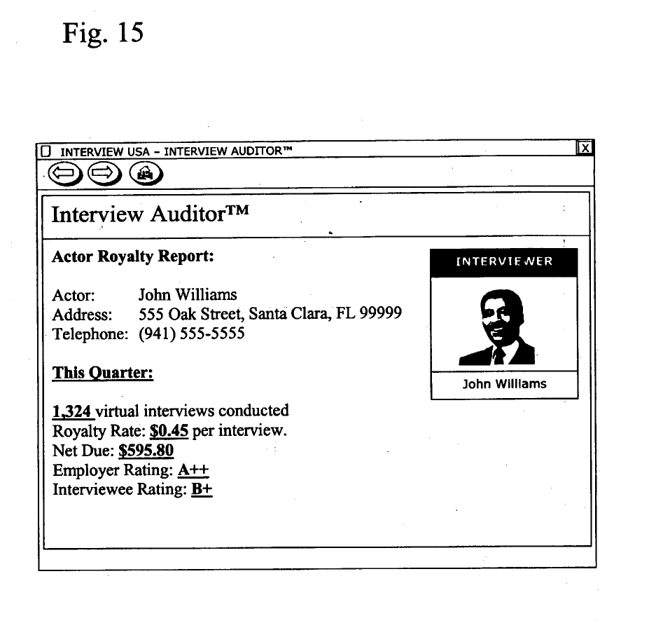

FIG. 18 is a diagrammatic view of exemplary table relationships for created dependencies between questions.

FIG. 19 is a diagrammatic view the parent-child question dependency method.

FIG. 20 is an isometric depiction of an interview booth according to an embodiment of the invention.

FIG. 21 is a partially sectional isometric depiction of an interview booth according to an embodiment of the invention.

FIG. 22 is a diagrammatic view of a video caching method according to an embodiment of the invention.

FIG. 23 is a computer screen interface displayed to an end user to initiate an interview.

FIG. 24 is a computer screen interface displayed to an end user to log into the system.

FIG. 25 is a computer screen interface displayed to an end user to show a tutorial on how to use the system.

FIG. 26 is a computer screen interface displayed to an end user to authorize a background check.

FIG. 27 is an alternative computer screen interface displayed to an end user to authorize a background check by voice recognition of the end user's spoken response.

FIG. 28 is a computer screen interface displayed to an end user to select an interview based on occupation.

FIG. 29 is a computer screen interface displayed to an end user having a video interviewer broadcast.

FIG. 30 is a computer screen interface for reviewing applicant interview responses.

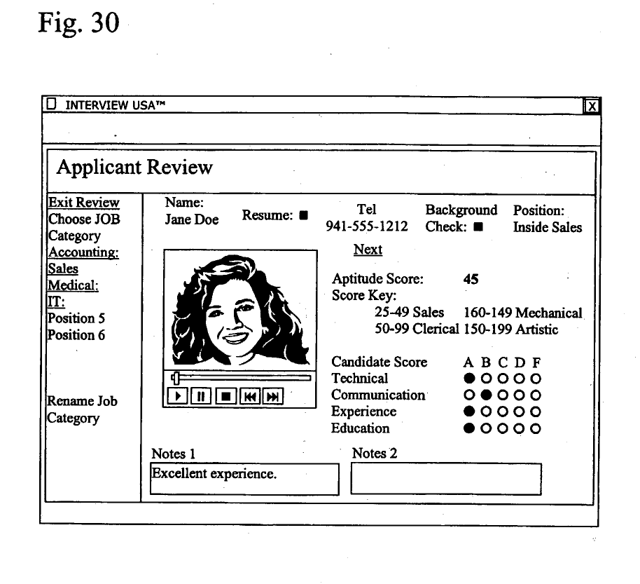

FIG. 31 is a computer screen interface for reviewing workplace accident reports.

FIG. 32 is a computer screen interface for generating human services reports.

### DETAILED DESCRIPTION

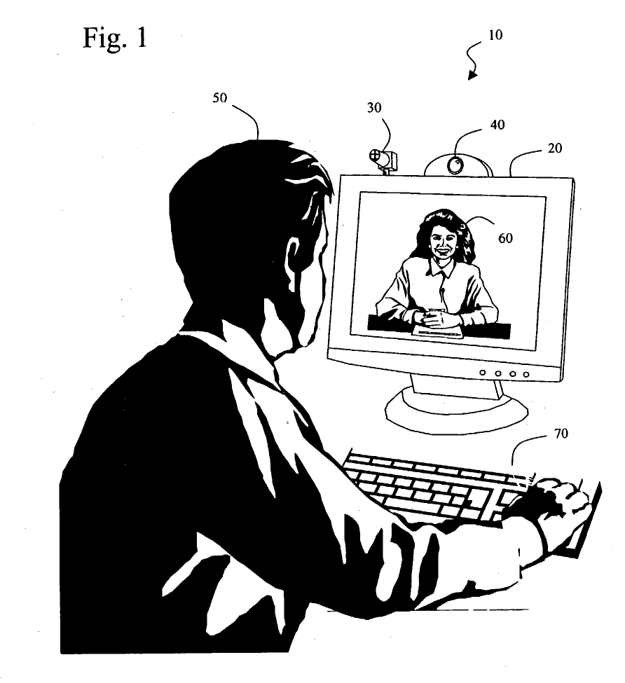

In FIG. 1, an embodiment of the invention is depicted. A client interface 10 includes a video monitor 20, audio input device 30 and video capture device 40. An interview subject 50 views a prerecorded interviewer 60 on the video monitor 20. Responsive to questions presented by the interviewer 60, interview subject 50 responds as he would in a live interview. The answers provided by interview subject 50 are captured by both the audio input device 30 and the video capture device 40. In addition, a keyboard 70 is provided in this embodiment although alternative embodiments of the invention may utilize touch-screens, mice, trackballs or voice commands for end-user control of the system. An advantage of the present invention is that the visual nature of the interviewer 60 provides a more conversational aspect to the process. As a result, the responses provided by the interview subject 50 are more fluid and natural. In prior art systems; the interview subject 50 reads text-based prompts from the computer screen, which results in an inferior, artificial simulation of a live interview.

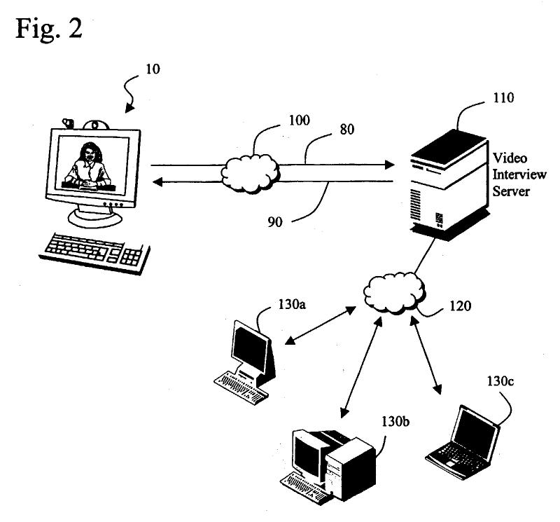

FIG. 2 illustrates communication pathways according to an embodiment of the invention. The client interface 10 sends 80 and receives 90 data through a network connection 100 to a video interview server 110. The data sent 80 includes audio and video capture of the interview subject 50. This data may either be streamed to the server 110 or cached at a store communicatively coupled to the client interface 10 until it is transmitted at a predetermined time or at the conclusion of an interview session. In an alternative embodiment of the invention, the audio and video capture data persists in a store local to the client interface 10 and is accessed through a peer-to-peer network protocol.

Whether the data is cached or streamed is largely dependent on the quality of the media captured and the bandwidth of the network connection. For example, to stream uncompressed 29 frame-per-second, 720 pixels by 480-pixel digital video, a relatively fast network connection is required. While the quality of the media is excellent at these settings, network logistics may require that this video be compressed with a suitable codec and cached for asynchronous transmission. Alternatively, lower frame rates with lower resolution may support streaming video on substantially slower network connections. An advantage of the present invention is that interview sessions and evaluations may take place asynchronously. That is, the interview may be administered to the interview subject 50 at one time and later review by a decision making person or decision-making committee at a different time and location.

The server 110 may include a single server, an array of distributed servers, or an array of task specific servers depending on the workload requirements. The server 110 may include a web server that generates the graphic user interface presented on the client interface 10. Alternatively, the server 110 may distribute a local application that is installed on the end-user machine. Reviewer interfaces 130a-c in different locations are communicatively coupled by a second network connection 120 to the server 110. Reviewer interfaces 1 30a-c provide playback and score tools to evaluate the suitability of the interview subject 50 for a position.

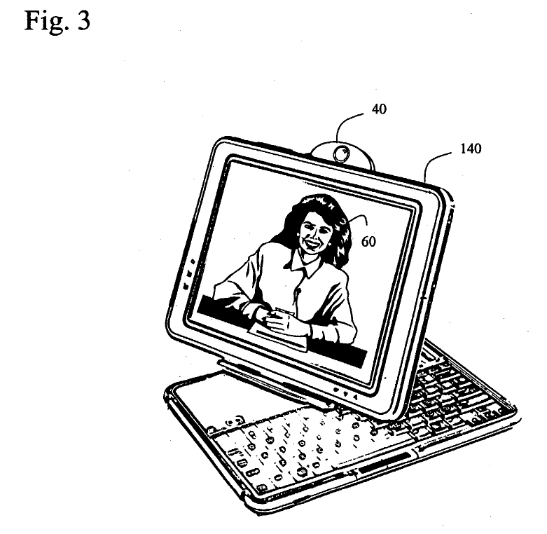

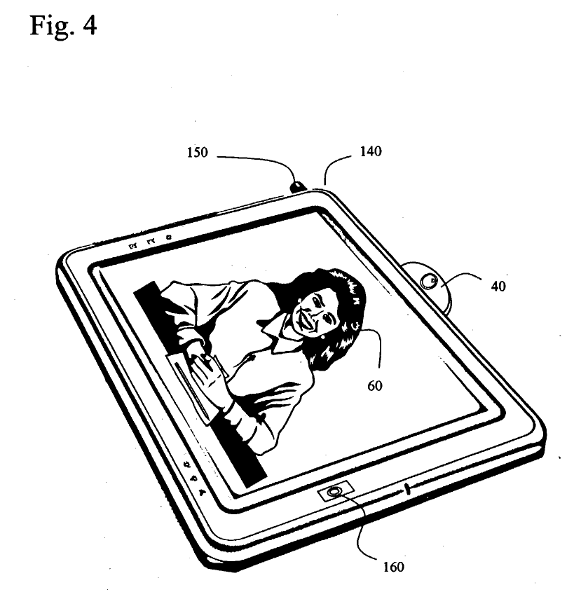

In FIGS. 3-4, a portable embodiment of the client interface 10 is provided as portable interface 140. The portable interface 140 depicted is in the configuration of a tablet PC available from vendors such as Compaq, Toshiba and ViewSonic. An advantage of the tablet PC configuration is that they accept both touch-screen and keyboard input. Tablet PCs are also offered with integrated wireless network connections such as IEEE 801.11 (WiFi) and/or IEEE 801.15 (BlueTooth). Plug in cards may also add cellular data connections and GPS tracking information. One application of this portable interview system is for social services such as child protection or elderly assistance. Since many social service procedures must abide by strict regulations, the consistent presentation of questions by the interviewer 60 insures both consistency in the interaction and legal compliance of the duties of the social service worker. Furthermore, the video capture device 40 on the portable interface 140 may serve to not only record the interview subject, but also the surrounding environmental conditions. Some social service application may lead workers into potentially dangerous conditions. Accordingly, an embodiment of the portable interface 140 configuration may include a wireless connection 150 and a panic button 160 whereby activation of the panic button generates a notification transmitted wireless to a response center for assistance.

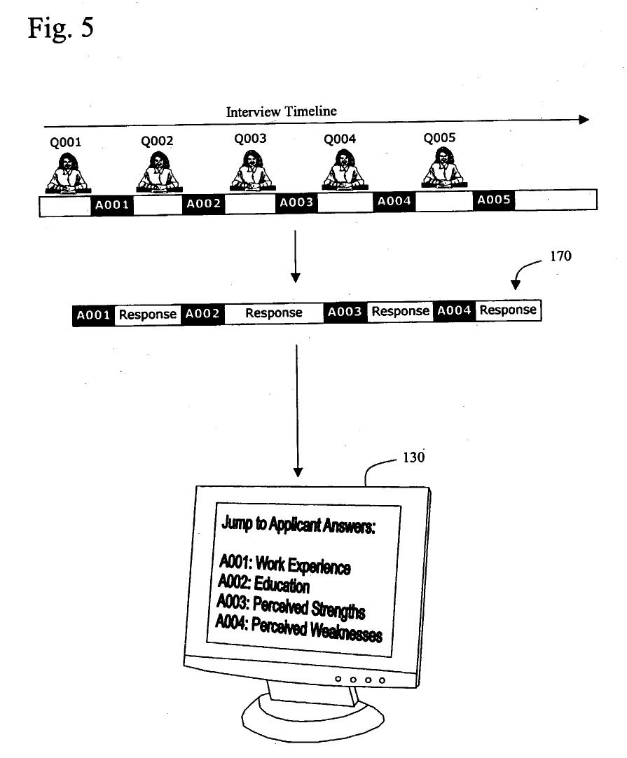

A significant advantage of the present invention is the timesavings enjoyed by human resources staff that would normally have to be physically present in numerous interviews repeating the same questions. In addition, many of the initial questions are merely perfunctory and only asked under the standard protocol of the interview process. In FIG. 5, an interview timeline is provided with five questions Q001-Q005 and five answers A001-A005. Each question is assigned a unique identifier to which each answer is associated. In a preferred embodiment, a individual reviewing the answers provided by the interview subject 50 may wish to jump to specific answers that have critical importance in the decision making process. Accordingly, the present invention employs a non-linear approach to indexing interview subject 50 answers. There are several approaches that may be employed. In a first approach, each answer provided by the interview subject 50 is saved as an individual file. For example, if the interview subject 50 is assigned a unique identifier of 1550 then her answer to question number 4 might be saved as 1550_A004.AVI, 1550_A004.MPG, 1550_A004.ASF or the like. Alternatively, a unique key value may be generated in a first database table that is relationally linked to a table having interview subject data and a table having question identifier data. In an alternative embodiment, A001-A005 may be stored in a single file containing a plurality of headers that mark the starting point of each answer provided by the interview subject 50. A codec may then be used to parse the text data representative of the question from the audio and video data representing the response.

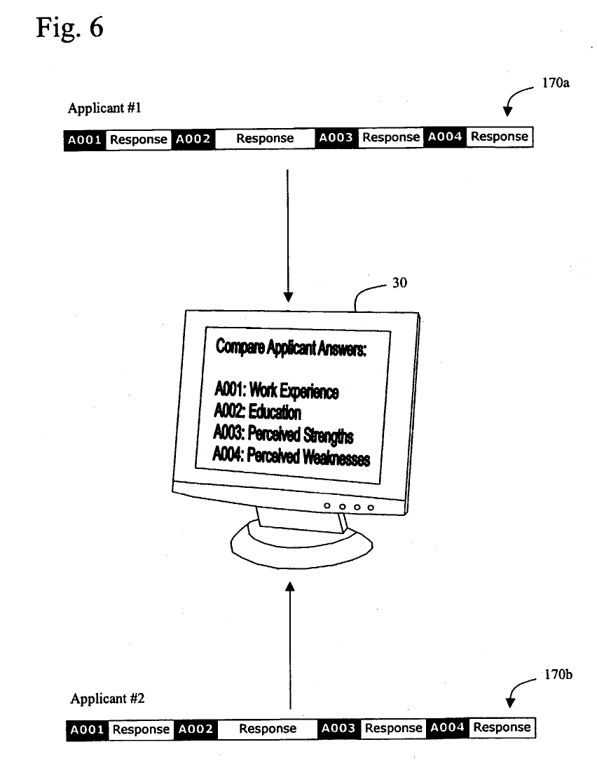

An advantage of indexing the responses provided by the interview subject 50 is illustrated in FIGS. 6-7. Applicant #1's responses are provided in file 170a while Applicant #2's responses are provided in file 170b. Within the reviewer interface 130, responses from both applicants' may be viewed in a side-by-side arrangement as shown: in FIG. 7. This feature may be particularly useful should a decision maker find two applicants closely qualified for a single position.

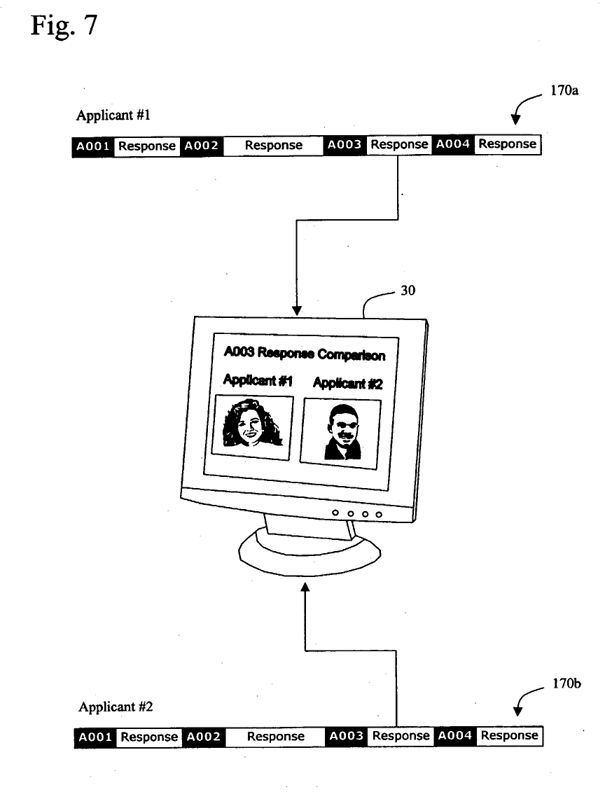

In FIG. 8, an embodiment of the invention provides for a search query 180 that is executed against a database of employee performance data 190 that then retrieves from the server 110 the recorded interview of a highly valued employee GF332B. Her profile is compared side-by-side with Applicant #1. By using objective data, namely the highly valued employee was a correct hiring decision; new applicants may be compared along side the benchmark. In addition, an alternative embodiment of this method may be used to train decision makers by presenting the past interview answers of well performing employees and poorly performing employees. Decision makers that prefer poorly performing employees based on their past interview answers would be retrained in the evaluation process.

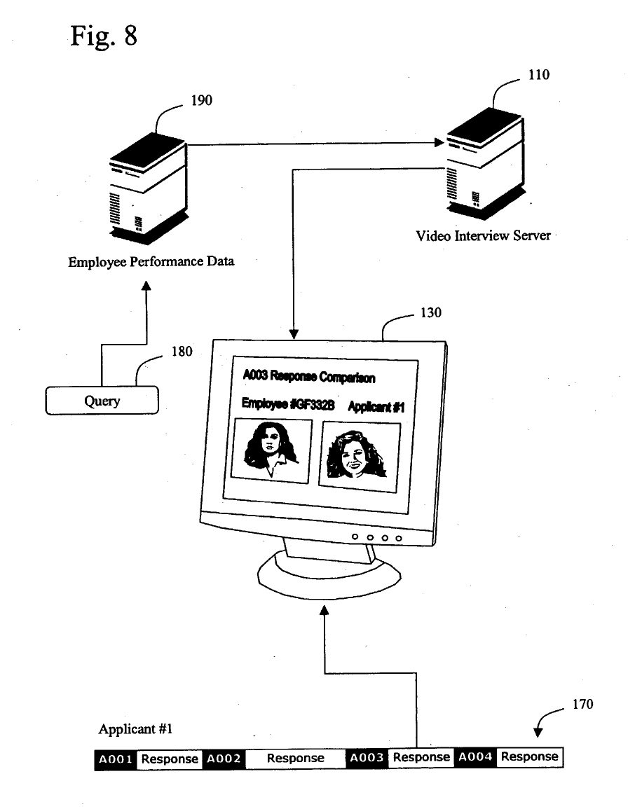

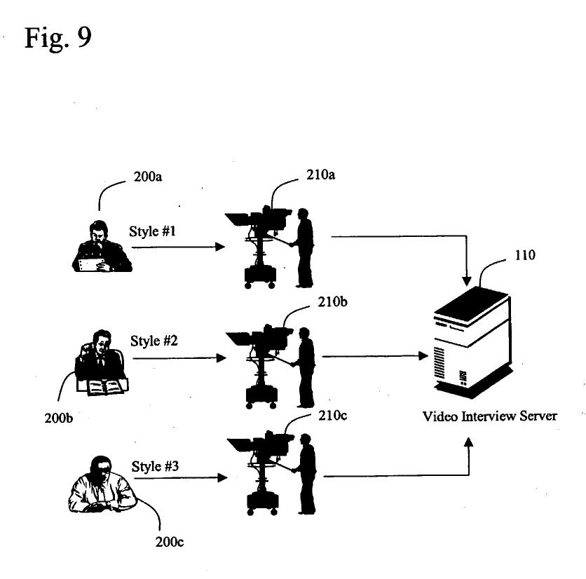

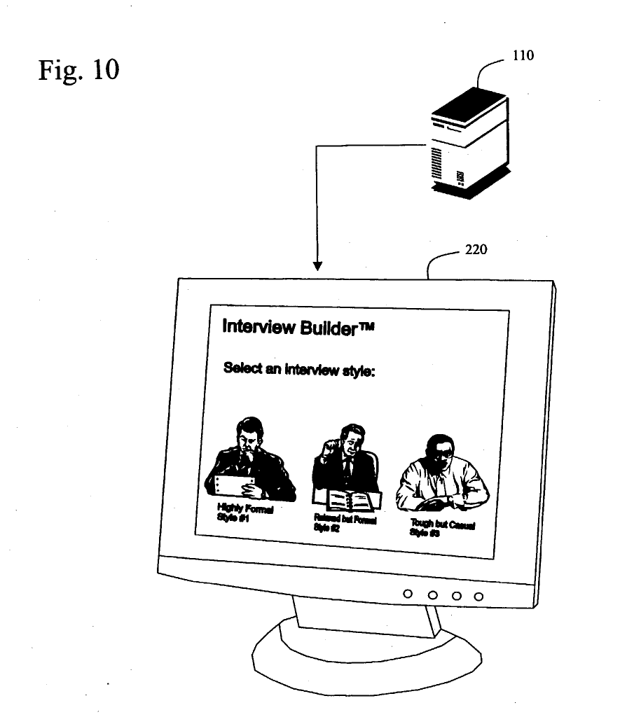

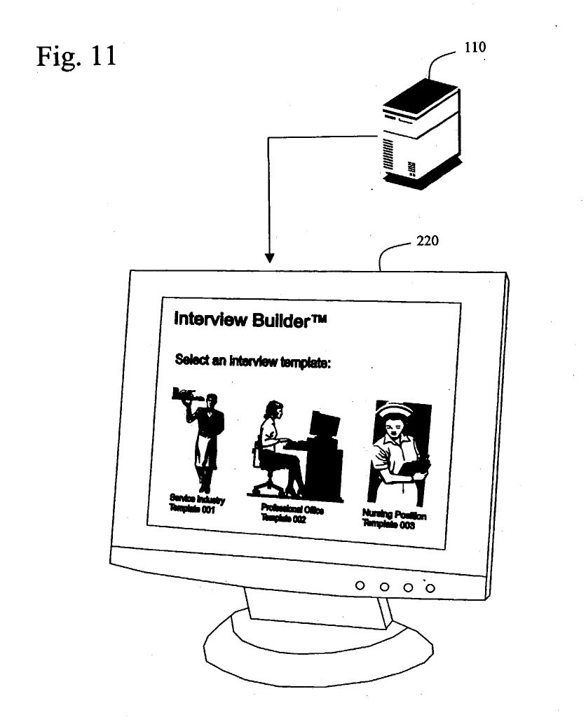

Interview styles vary across industries. A candidate for a graphic artist position might expect a more casual interview compared with a position for an investment banker. Even within the same industry, individual companies and government institutions subscribe to different techniques and theories in the interview process. Accordingly, FIG. 9 illustrates the capture of three different interviewer styles 1-3. Interviewer actor's 200a-c may be varied by age, gender or race to accommodate the objectives or preferences of hiring process. Each interview actor 200a-c is captured 210a-c using standardized interview questions. The video clips of each interviewer actor are then stored on the server 110. In FIG. 10, an interview construction interface 220 is provided whereby the particular style and visual appearance of the interviewer actor may be selected. In FIG. 11, a template of questions may be selected according to predetermined groupings such as industry, occupation or other criteria. In one example shown in FIG. 12, a template is selected for interviewing candidates for a nursing position. Subgroups of additional questions may be selected or de-selected according to the hiring company's preferences. In the present example, the nursing position may involve working with elderly patients that have terminal illnesses. At the bottom footer of the computer screen interface, a running total of the interview attributes is provided. In FIG. 13, individual questions are selectable under the subcategory of “Working with the elderly questions.” A preview of each question is viewable so that the individual building the custom interview may carefully consider whether a question should be included or excluded.

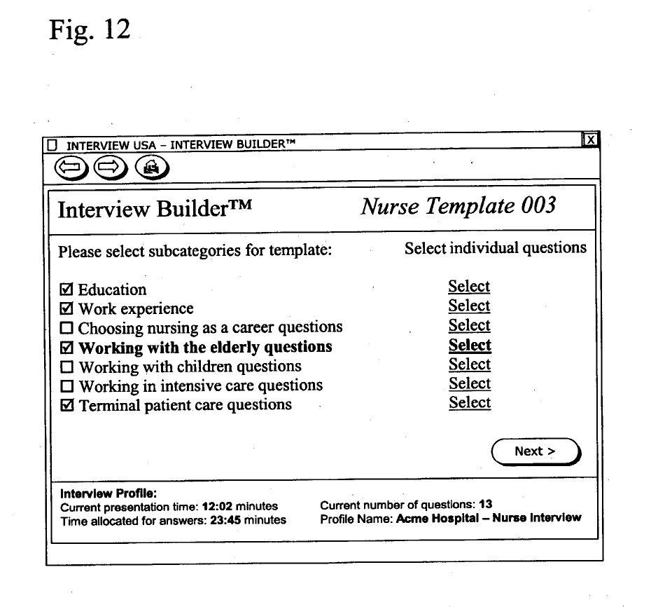

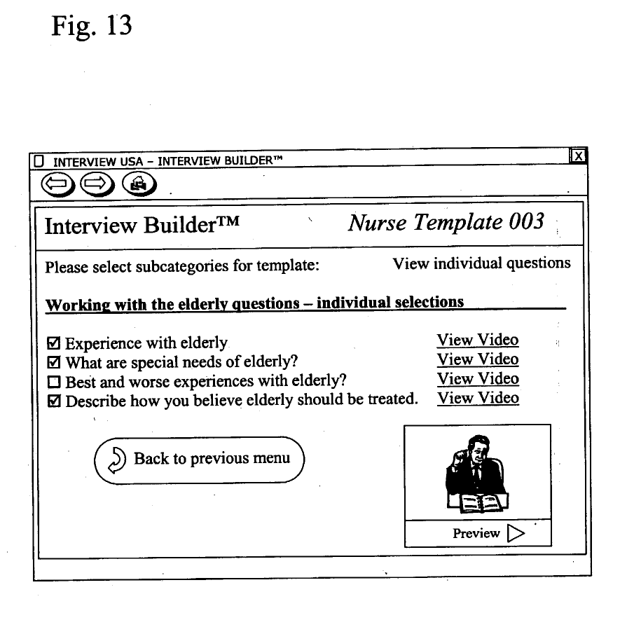

In FIG. 14, a number of exemplary tables and their relationships are provided. Each table is provided with a unique auto-incrementing primary key integer, known in the art of relational database design. For each question related, video clips, legal compliance, styles and interview actors are relationally associated. In FIG. 15, a report is generated to calculate a royalty payment for an interviewer actor based on the frequency his interviews are broadcasted. In addition, questions presented to both the employer and the applicant may solicit feedback about the interview actor's performance where a rating value can be calculated.

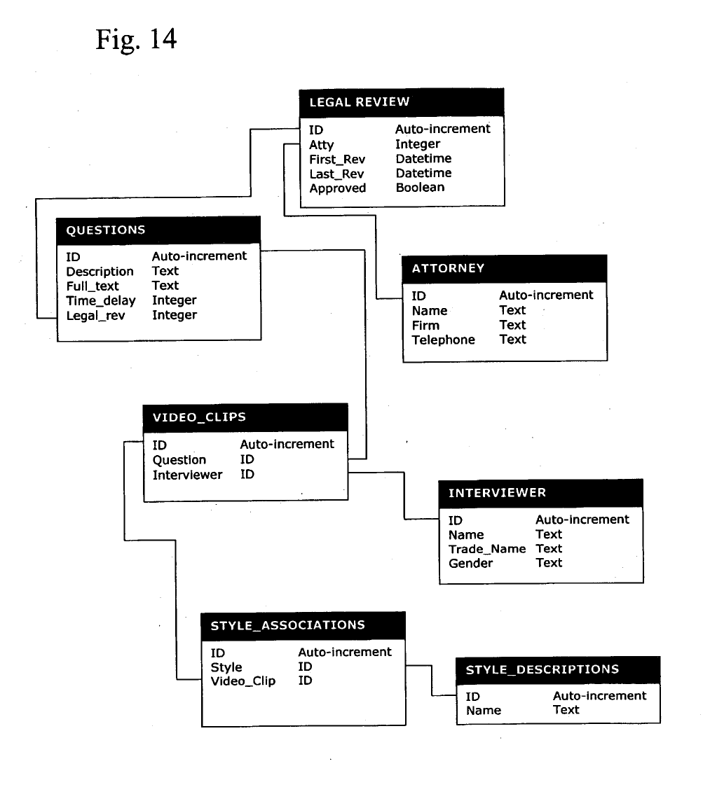

Another advantage of the present invention is the controlled nature in which the interview questions are presented. However, prior to the initial recording of the questions as illustrated in FIG. 9, each interview question may be evaluated for legal compliance. Improper questions, even if unintentional, may provide grounds for a lawsuit against the potential employer. In FIG. 16, a legal compliance report is provided listing the total number of validated questions, questions pending validation by outside counsel and questions that are due for reexamination by counsel in 30 days. In an embodiment of the invention, qualified counsel that reviews each question for compliance may be remunerated based on the number of times the approved question is presented in an interview. An advantage of this payment method is that counsel is compensated in proportion to the potential legal liability that may be incurred if his or her approval of the question was in error. Another advantage of this method is that the system operator may initially defer legal costs.

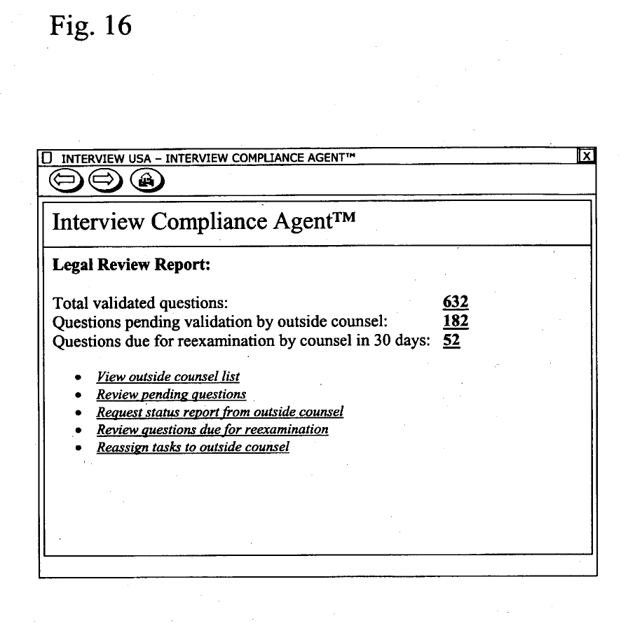

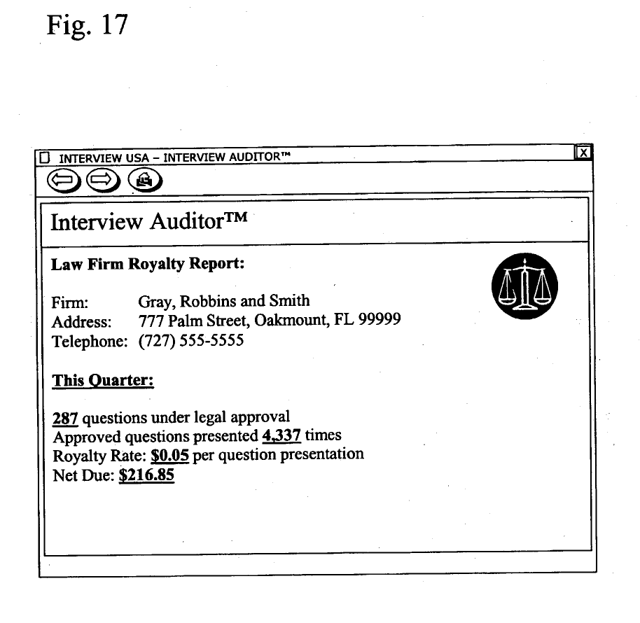

Live interviews are not linear processes. One line of questions may be presented depending on the answer to a first question. In FIGS. 18-19, an embodiment of the invention establishes dependencies between different questions. In FIG. 18, relational tables encapsulate data, which drives the logic to present or skip a question depending on the answer to a preceding question. In FIG. 19, a parent question is presented. The answer is then evaluated 230 to determine whether child question 1 or child question 2 is presented before resuming the interview with child question 3.

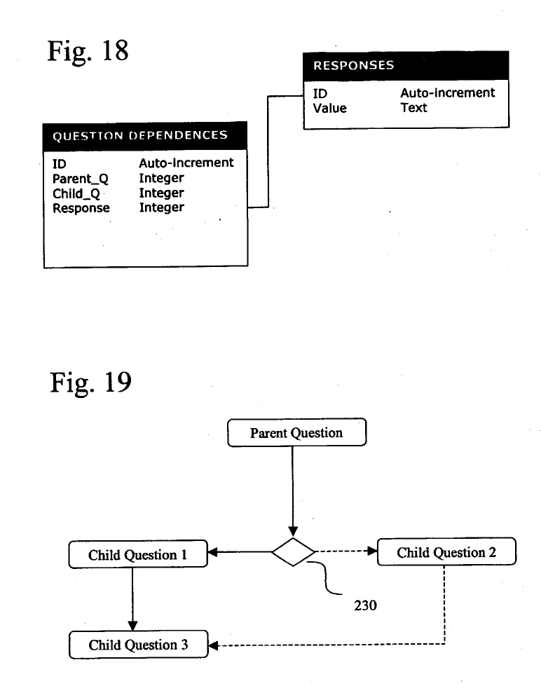

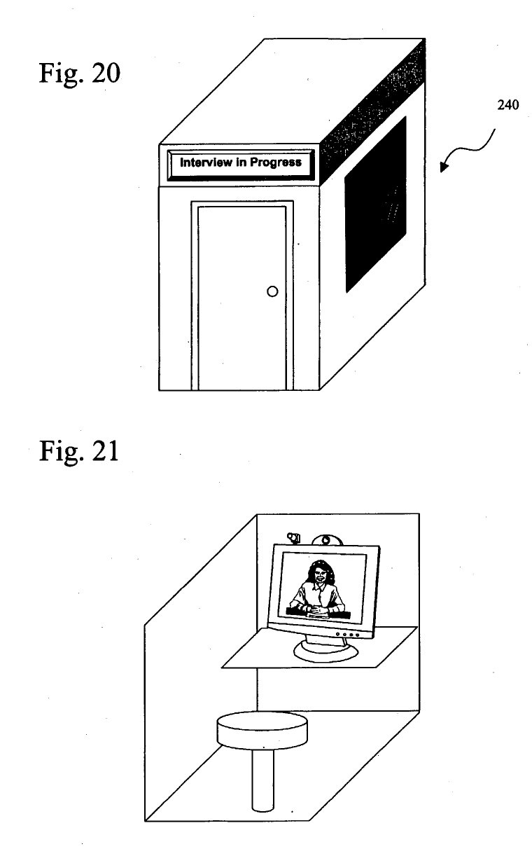

In FIGS. 20-21, a design for a private kiosk 240 is provided for administering the interview process. In an embodiment of the invention, the kiosk, or a plurality thereof, are transported to job fairs to administer interviews. Additionally, one or more kiosk may be placed in businesses that frequently have positions open such as large retail establishments.

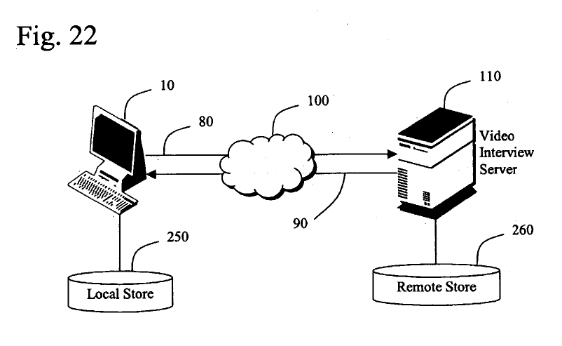

FIG. 22 illustrates an embodiment of the invention that updates information between the client interface 10 and the server 110 on a predetermined schedule or criteria. A local store 250 of data is communicatively coupled to the client interface 10, preferably in the form of a hard drive of sufficient capacity to store the interview actor video and the resultant responses captured at the client interface 10. By caching the large audio-visual files locally, the responsiveness of the system is improved and does not suffer from network restrictions. As new interview responses are available, the data is transmitted to the server 110 and saved on a remote store 260, which is local to the server 110.

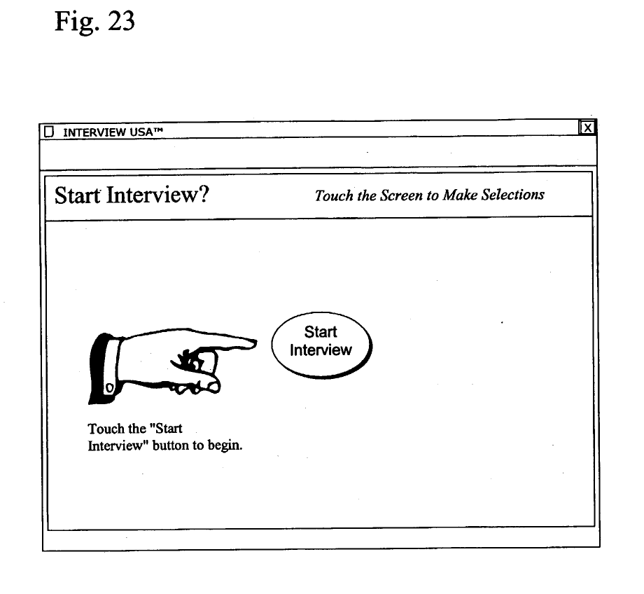

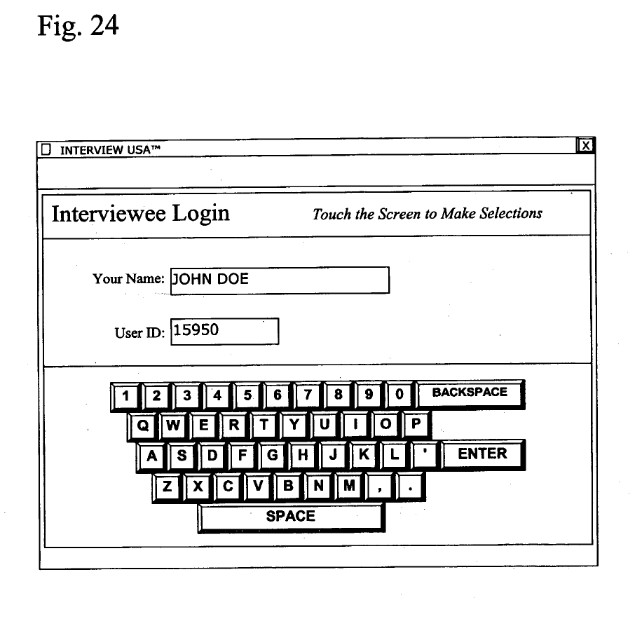

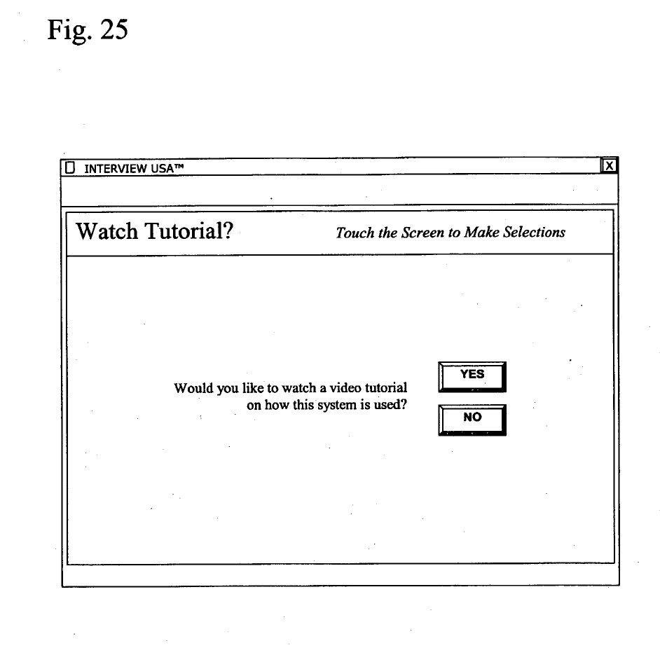

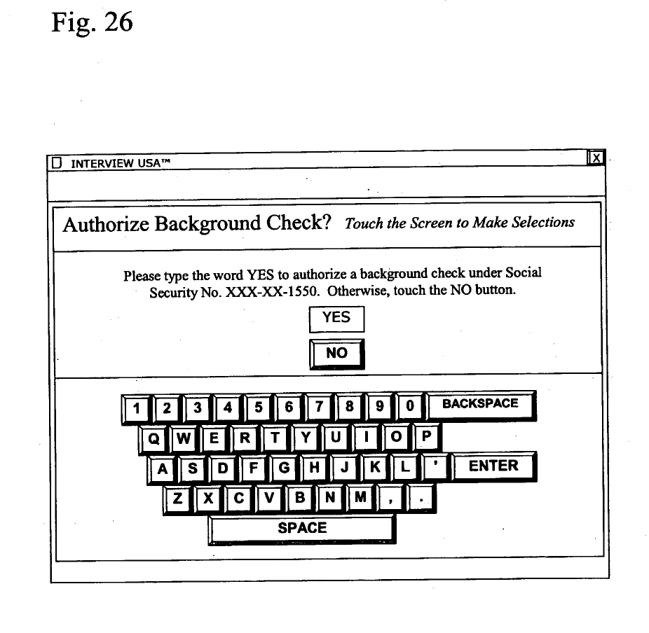

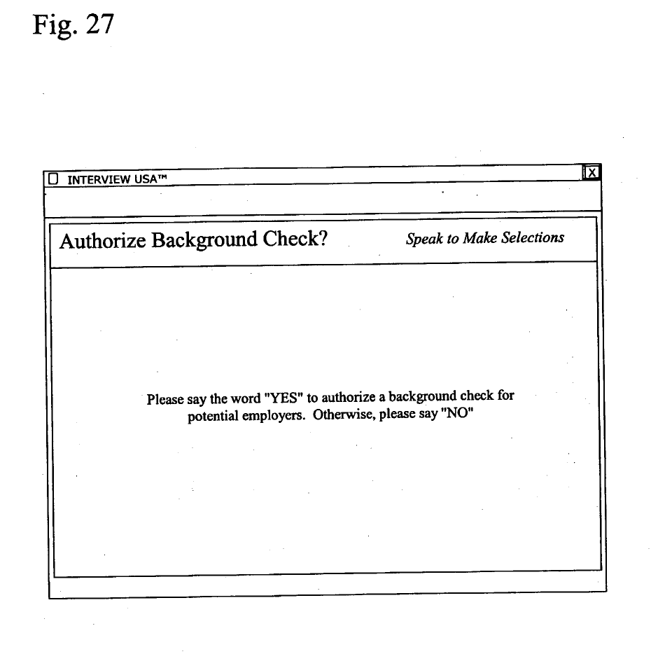

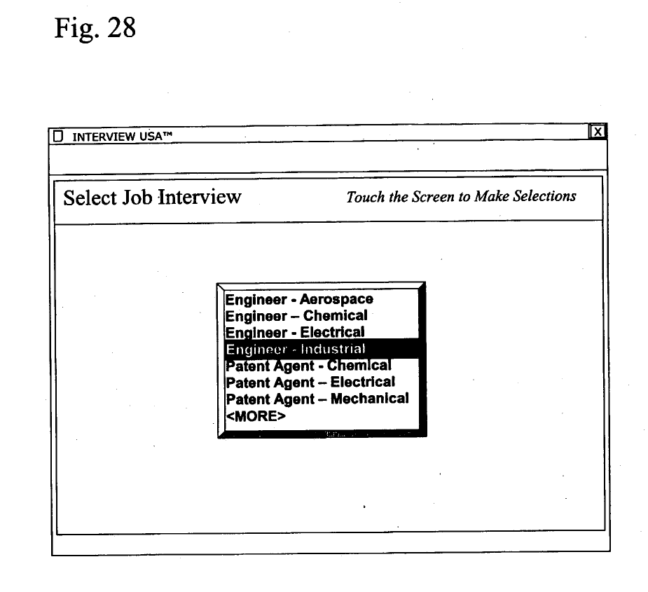

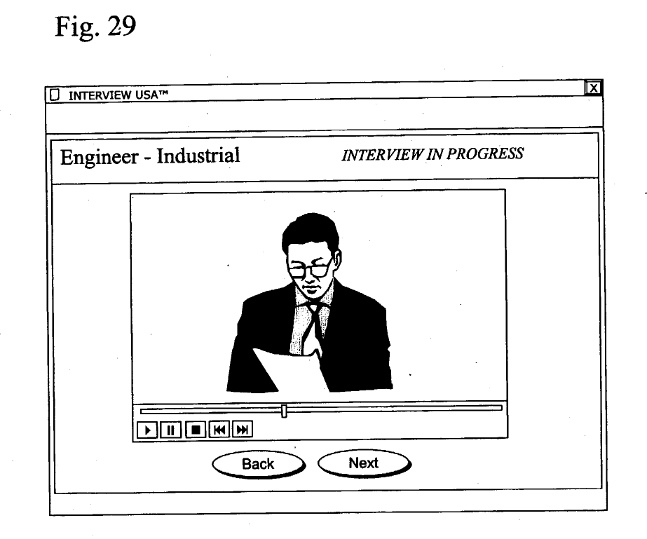

FIGS. 23-29 illustrate an exemplary interview process conducted at the client interface 10. In FIG. 23, a touch screen interface is provided whereby the applicant touches a graphic to initiate the interview process. A virtual keyboard is provided in FIG. 24 for the applicant to enter identifying data to associate responses generated in the process with the applicant. Tutorials and context sensitive help may be provided throughout the process, as provided in FIG. 25. Background checks may be authorized as shown in FIG. 26 whereby the applicant types in the individual letters to the word YES to approve the background check. An alternative embodiment of the invention shown in FIG. 27 utilizes voice recognition for end-user selections on the system. In this case, instead of typing in the word YES to approve the background check, the applicant simply speaks either the word “yes” or the word “no.” In FIG. 28, the applicant is presented with a number of positions to which he or she may apply. The positions listed may be determined by a preexisting profile for the applicant or may be limited by other criteria. In FIG. 29, the system plays a video of the interview questions. After a question is asked, the video automatically pauses to allow the applicant to respond. The system may record both the audio from the question asked and the video and audio response from the applicant. The recording does not pause until the entire session is complete. The applicant touches the screen to play the next question. It is preferred that there be no delay or buffering in the video once the interview session starts. The process repeats for all the questions. In most cases the system allows a predefined time limit for most responses. If the time limit is about to expire, a count down timer displays the time left to complete the answer.

FIG. 29 depicts a graphic user interface whereby a screener can review previously captured video responses by applicants. The screener can view the video, background check information, resume and comments from other screeners. The screener can then add comments to the applicant's record. The next time the video is viewed, the comments from the screener are also on the screen. Using the recordings, the screener can eliminate unsuitable applicants and schedule only the suitable applicants for a face-to-face interview.

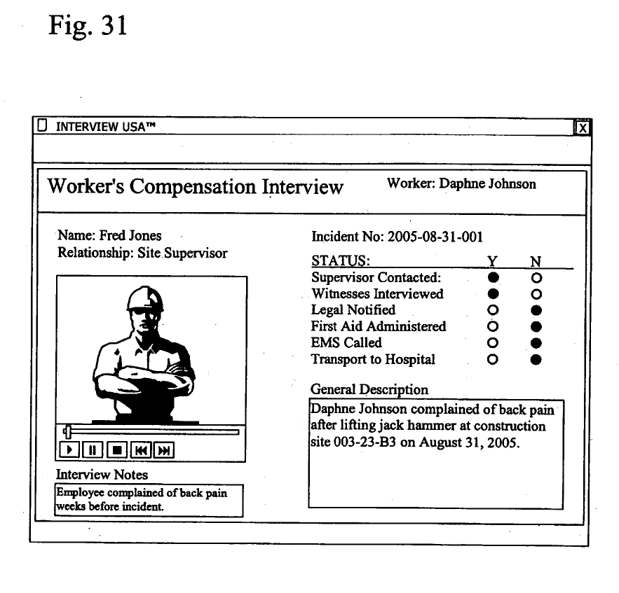

An alternative embodiment of the invention is provided in FIG. 31 whereby employees injured on the job and witnesses that viewed the incident are interviewed by the system. Preferably, a portable system such as described in FIGS. 3-4 is rapidly deployed contemporaneous to the incident so that testimony and observations from all available witnesses is memorialized.

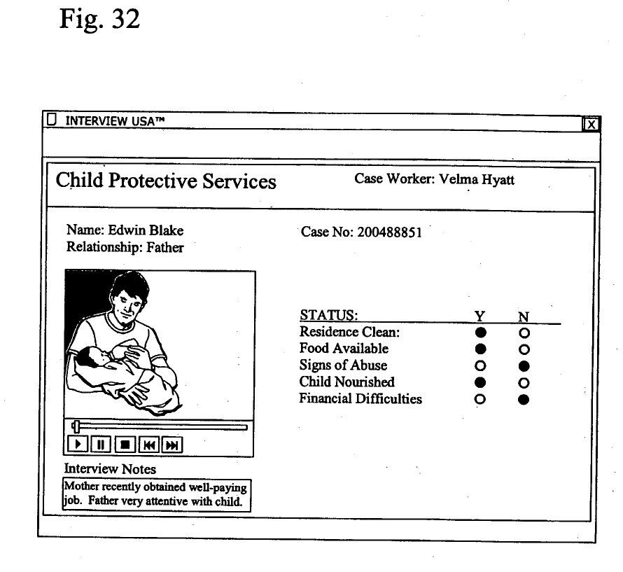

In yet another embodiment of the invention, both video recording and reporting may be integrated for human services workers. In the example shown in FIG. 32, a child protective report is generated that includes video of not only the individual subjects of the report, but also the conditions of the living environment. By requiring video capture during the worker's visit, the agency insures that the workers attend and record each scheduled visit.

It will be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention, which, as a matter of language, might be said to fall therebetween. Now that the invention has been described,

1. A method of automating an interview process comprising the steps of: broadcasting at least one or more prerecorded video interview questions to an interview subject at a first location; video capturing responses to the questions by the interview subject; saving the responses on a storage device; and replaying the responses at a second location.

2. The method of claim 1 further comprising the steps of associating each video captured response with the prerecorded video interview question and indexing an array of responses whereby an individual reviewing the interview subject's responses may skip to a response to a single prerecorded interview question.

3. The method of claim 2 whereby each video captured response is stored as an individual file.

4. The method of claim 2 whereby a plurality of video captured responses are stored as a single file with headers identifying the start of each response to a single prerecorded interview question.

5. The method of claim 4 whereby alphanumeric data associated with the interview subject is stored in the single file.

6. The method of claim 5 wherein the single file is encrypted.

7. The method of claim 2 further comprising the step of presenting the responses by two or more interview subjects substantially simultaneously at the second location for comparison.

8. The method of claim 7 whereby at least one of the two or more interview subjects is an employee having a known performance record.

9. The method of claim 7 further comprising the step of broadcasting preselected model interview subjects to a reviewer for evaluation and appraising the reviewer's evaluation abilities in selecting a preferred model interview subject.

10. The method of claim 1 further comprising the step of generating a hash of the interview subject responses.

11. The method of claim 10 whereby the hash is transmitted to a trusted third party.

12. The method of claim 1 further comprising the steps of: establishing an array of predetermined interview questions; communicating the array of questions to legal counsel; approving the legality of the array of questions; and presenting only those questions that have been approved by legal counsel.

13. The method of claim 2 further comprising the steps of recording the date when each question was last reviewed for legality and associating a predetermined expiration date for revisiting the legality of each question.

14. The method of claim 2 further comprising the steps of recording the frequency in which each approved question is broadcast to an interview subject and paying a royalty to legal counsel for each broadcast.

15. The method of claim 1 further comprising the steps of establishing a plurality of interview styles, recording actors presenting interview questions in accordance with each style, and providing a selection means for selecting the style of interview to be broadcast.

16. The method of claim 15 whereby the interview subject selects the style.

17. The method of claim 15 whereby an interview administrator selects the style.

18. The method of claim 1 further comprising the steps of grouping an array of related questions into a template and providing a selection means for selecting the template.

19. The method of claim 18 whereby individual questions may be selected from within the template.

20. The method of claim 19 whereby prerecorded video interview questions may be previewed.

21. The method of claim 1 further comprising the steps of associating each prerecorded video interview question with an actor playing the part of the interviewer and paying a royalty to the actor for each broadcast of the question.

22. The method of claim 1 wherein a plurality of the prerecorded video interview questions are broadcast non-linearly.

23. The method of claim 22 wherein the broadcast of one or more prerecorded video interview questions is dependent upon an interview subject's response to one or more preceding questions.

24. The method of claim 23 wherein the interview subject's response is captured by a mechanical input device.

25. The method of claim 23 wherein the interview subject's response is captured by digital voice recognition.

26. The method of claim 1 further comprising the step of capturing biometric data concurrently with responses to the questions by the interview subject.

27. The method of claim 26 wherein the biometric data is polygraphic-based.

28. The method of claim 26 wherein the biometric data is physical attribute-based.

29. The method of claim 26 wherein the biometric data is speech-based.

30. The method of claim 1 wherein the at least one or more prerecorded video interview questions are selectably broadcast in multiple languages.

31. The method of claim 1 wherein the first location is a kiosk.

32. The method of claim 1 wherein the first location is a home computer terminal.

33. The method of claim 1 wherein the first location is mobile and the prerecorded video interview questions are broadcast by a portable computing device.

34. A method of automating an interview process comprising the steps of: broadcasting at least one or more prerecorded video interview questions to an interview subject at a first location; video capturing responses to the questions by the interview subject; saving the responses on a storage device; indexing an array of responses; replaying the responses at a second location; and recording a first evaluation of the interview subject at the second location by a first party.

35. The method of claim 34 further comprising the step of displaying the first evaluation of the first party and the responses by the interview subject to a second party, and recording a second evaluation of the interview subject by the second party.
